(19) United States
(12) Patent Application Publication
(10) Pub. No.: US 2009/0222762 A1
(43) Pub. Date: Sep. 3, 2009

(54) CASCADING ITEM AND ACTION BROWSER

(75) Inventors: Allen Denver, Mililani, HI (US); Mohsen Agsen, Honolulu, HI (US); Craig Symonds, Honolulu, HI (US); Tracey Trewin, Carnation, WA (US); Jean-Pierre Duplessis, Redmond, WA (US); Chris Lovett, Woodinville, WA (US); Jacob I. Meyer, Honolulu, HI (US); Scott R. Marison, Honolulu, HI (US)

Correspondence Address: MICROSOFT CORPORATION, ONE MICROSOFT WAY, REDMOND, WA, 98052, US

(73) Assignee: MICROSOFT CORPORATION, REDMOND, WA (US)

(21) Appl. No.: 12/040,191

(22) Filed: Feb. 29, 2008

(51) Int. Cl. G06F 3/048

(52) U.S. Cl. 715/793; 715/810

(57) ABSTRACT

In one or more embodiments, a cascading item and action browser enables items and associated actions to be displayed. In at least some embodiments, items are presented in a column and can be selected by a user. Responsive to selecting a particular item or items, actions that can be performed on or relative to a selected item or items can be presented in a second adjacent column. From here, users can select one or more actions that can be performed on items presented in the first-mentioned column. Results of the action or actions being performed, at least some of which can include additional items, can then be presented in a next-adjacent column. Navigation through the items and actions displayed in their respective columns can then continue in a cascaded fashion.

### BACKGROUND

Existing browsers of structured relationship information typically allow navigation between individual items in a hierarchical way. For example, a parent/child relationship may exist between two items such as a folder and a file. A browser may then represent the folder with a visual “container” which is linked to a container that represents the file. Using this type of structure can allow the user to traverse the hierarchy defined by the parent/child relationship.

This type of structure, however, only displays individual items that are hierarchically-related. In addition, navigating between different objects that are not hierarchically-related generally requires the user to initiate a new navigation using a new root object, such as a folder.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one or more embodiments, a cascading item and action browser enables items and associated actions to be displayed. In at least some embodiments, items are presented in a column and can be selected by a user. Responsive to selecting a particular item or items, actions that can be performed on or relative to a selected item or items can be presented in a second adjacent column. From here, users can select one or more actions that can be performed on items presented in the first-mentioned column. Results of the action or actions being performed, at least some of which can include additional items, can then be presented in a next-adjacent column. Navigation through the items and actions displayed in their respective columns can then continue in a cascaded fashion.

In at least some embodiments, individual columns that are displayed by the cascading item and action browser can be displayed in a common container or window. This provides for a degree of visual continuity between items and actions that are presented in the various columns.

### BRIEF DESCRIPTION OF THE DRAWINGS

The same numbers are used throughout the drawings to reference like features.

FIG. 1 illustrates an operating environment in accordance with one or more embodiments.

FIG. 2 illustrates an example user interface that includes one or more columns in accordance with one or more embodiments.

FIG. 3 illustrates an example user interface that includes one or more columns in accordance with one or more embodiments.

FIG. 4 illustrates an example user interface that includes one or more columns in accordance with one or more embodiments.

FIG. 5 illustrates an example user interface that includes one or more columns in accordance with one or more embodiments.

FIG. 6 illustrates an example user interface that includes one or more columns in accordance with one or more embodiments.

FIG. 7 illustrates an example user interface that includes one or more columns in accordance with one or more embodiments.

FIG. 8 is a flow diagram that describes steps in a method in accordance with one or more embodiments.

FIG. 9 illustrates an example system in accordance with one or more embodiments.

### DETAILED DESCRIPTION

Overview

In one or more embodiments, a cascading item and action browser enables items and associated actions to be displayed. In at least some embodiments, items are presented in a column and can be selected by a user. Responsive to selecting a particular item or items, actions that can be performed on or relative to a selected item or items can be presented in a second adjacent column. From here, users can select one or more actions that can be performed on items presented in the first-mentioned column. Results of the action or actions being performed, at least some of which can include additional items, can then be presented in a next-adjacent column. Navigation through the items and actions displayed in their respective columns can then continue in a cascaded fashion.

In at least some embodiments, individual columns that are displayed by the cascading item and action browser can be displayed in a common container or window. This provides for a degree of visual continuity between items and actions that are presented in the various columns.

In the illustrated and described embodiments, any suitable type of item can be used and represented in a particular column. To this end, items can constitute a wide variety of different types of items. Items can include, by way of example and not limitation, files, resources (such as computer resources), webpages, software objects, and/or records to name just a few. Further, examples of items can include, by way of example and not limitation, binary files, machine code, programming Classes, Methods, Fields, Properties, & Events, source code files, projects, references; Application Lifecycle Management resources such as source control systems, work items, defects, bugs, tasks, teams, programmers, change-sets, change-lists; software architectural elements like layers, sequences, flowcharts (and sub-elements), components, deployments, use cases, design patterns; software metrics like complexity measures, lines of code count, recursion depth, degree of distribution, performance speed and size characteristics. Further examples of items can include, by way of example and not limitation, photos, photographic categories, photographers, photographic subjects; network components such as hubs, routers, repeaters, end-nodes; music files, genres, composers, artists, lyricists, movies, directories, actors, writers; social groups, individuals, religions, practitioners, leaders; diseases, infected groups, non-infected groups; geographies, countries, regions, cities, states, counties, neighborhoods, families, males, females, highways, freeways, train tracks, roads, airstrips; criminal organizations, enterprises, crimes, victims, law-enforcement personnel, lawyers, attorneys, judges; corporate boards, CEOs, directors, conglomerates, regulatory agencies, commissioners, government officials, Representatives, Senators, Executive staff, languages, grammars, words, letters, novels, scripts and the like.

In the discussion that follows, a section entitled “Operating Environment” describes but one operating environment that can be utilized to practice the principles described herein in accordance with one or more embodiments. Following this, a section entitled “Example Cascading Item and Action Browser” describes an example browser in accordance with one or more embodiments. Following this, a section entitled “Example Method” describes a method in accordance with one or more embodiments. A section entitled “Example System” describes an example system that can be utilized to implement one or more embodiments.

Operating Environment

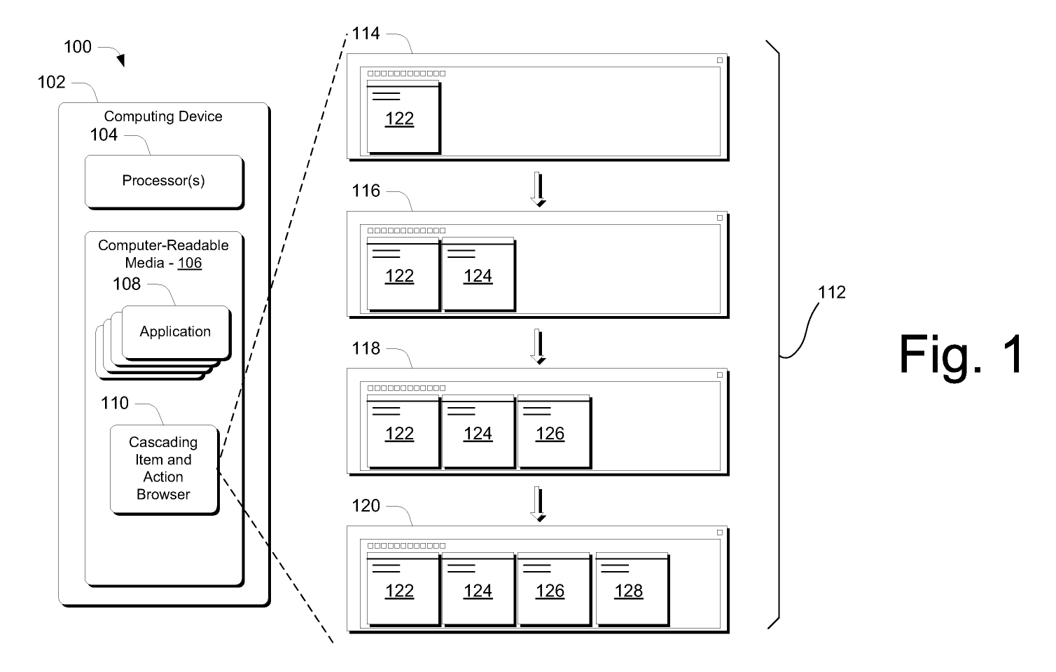

FIG. 1 illustrates an operating environment in accordance with one or more embodiments, generally at 100. Operating environment 100 includes a computing device 102 having one or more processors 104, one or more computer-readable media 106 and one or more applications 108 that reside on the computer-readable media and which are executable by the processor(s). The computer-readable media can include, by way of example and not limitation, all forms of volatile and non-volatile memory and/or storage media that are typically associated with a computing device. Such media can include ROM, RAM, flash memory, hard disk, removable media and the like. In addition, computing device 102 includes an application or software in the form of a cascading item and action browser 110. The cascading item and action browser can be a stand-alone component or, alternatively, can be integrated into another application.

Computing device 102 includes or otherwise has access to a database that includes information about items, their relationships to other items, and their relationships to actions that can be performed on or relative to the items. Any suitable database can be used. In at least some embodiments, the database is implemented as an XML database that uses XML to express relationships between various items and actions. The database can be a local database that is accessible to computer device 102. Alternately or additionally, the database can be located remotely and can be accessible via a network such as the Internet.

In operation, when the cascading item and action browser is launched, a user interface window is presented to the user and can include an initially-populated first column of items. In FIG. 1, four different instances of an example user interface window are shown generally at 120. In the top-most instance, a first column 122 is displayed and is initially populated with various items. As noted, any suitable items can be populated in column 122. Responsive to a user selecting one or more items in column 122, a second column, such as column 124, is provided and displays actions that are related to or otherwise pertain to the user's selection. From here, the user can select one or more actions and have those actions performed on the items that were selected in column 122. The results or outcome of performing the action or actions are displayed in a third column such as column 126. In many instances, the result or outcome of performing a particular action on a selected item will be another item. Examples of this are provided below.

If a user selects one or more items in column 126, another column can be provided and can display actions associated with the selected item or items. An example of such a column is shown at 128. In this manner, a user can select items and actions and can have a cascaded column structure rendered for them that provides a degree of visual continuity between items selected by the user, actions that can be performed on selected items, and the outcome of those actions.

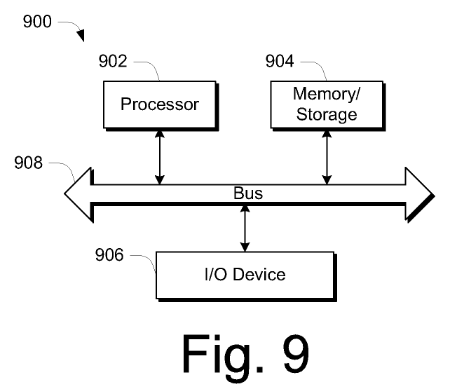

Computing device 102 can be embodied as any suitable computing device such as, by way of example and not limitation, a desktop computer, a portable computer, a handheld computer such as a personal digital assistant (PDA), cell phone, and the like. One example of a computing device is shown and described below in relation to FIG. 9.

Having discussed the general notion of an example operating environment in which various embodiments can operate, consider now a discussion of an example cascading item and action browser.

Example Cascading Item and Action Browser

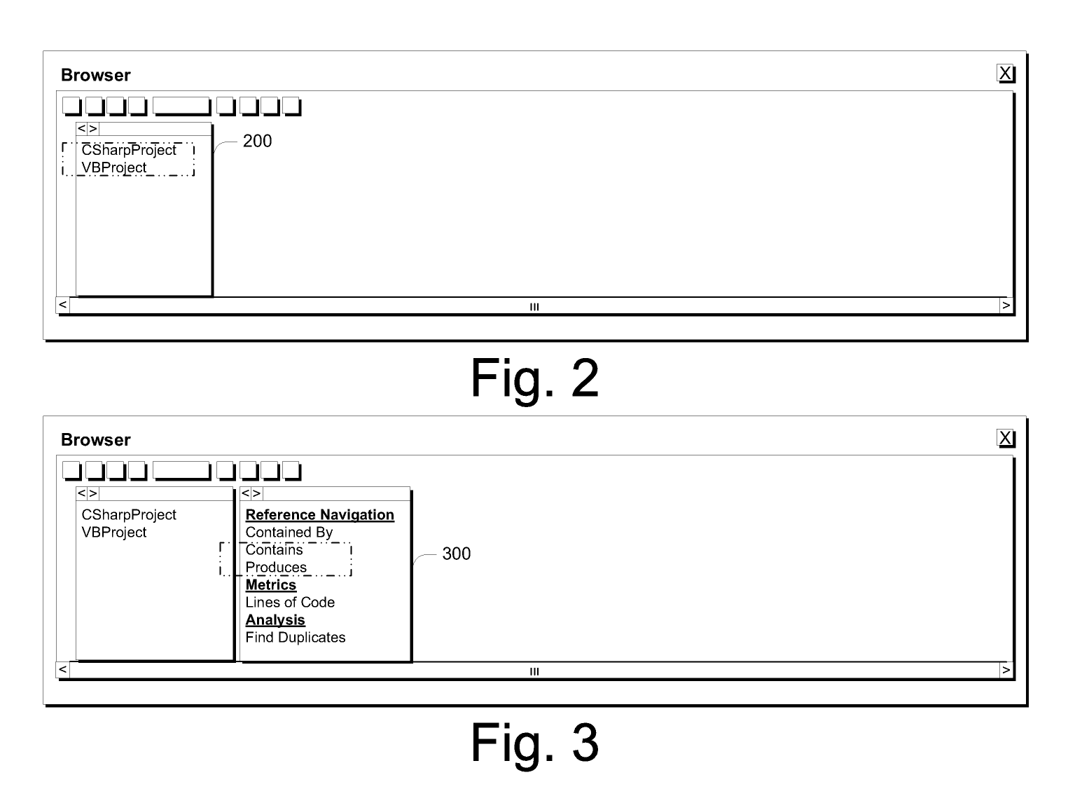

FIG. 2 illustrates an example browser window in accordance with one or more embodiments. In this particular example, the browser window includes a first column 200 which has been auto-populated with two items that can be considered as “roots”. In this example, the items pertain to software programming projects. As noted above, however, any suitable items can be represented in a column.

Assume now that a user selects both of the listed projects, as indicated by the dashed line. In at least some embodiments, responsive to the user's selection, the browser renders a second column, such as that shown at 300 in FIG. 3, and populates the column with actions that are relevant to the two selected items. In at least some embodiments, when the user makes a selection, the browser uses the above-mentioned database to ascertain actions that are relevant to the user's selection. In one or more embodiments, listed actions can be categorized to facilitate the user's browsing activities. For example, in FIG. 3 three different categories are shown—“Reference Navigation”, “Metrics” and “Analysis”. Underneath these categories, relevant actions appear.

Having a number of actions listed in column 300 provides the user with an opportunity to select an action or actions and have that action or actions performed on items that were selected in column 200. In the present example, the user has selected two actions—“Contains” and “Produces”—as indicated by the dashed line. Responsive to this selection, the browser creates another column, such as column 400 in FIG. 4. Here, column 400 is populated with content resulting from performing a “Contains” action, and content resulting from performing a “Produces” action for the items that were selected in column 200. In this particular example, a number of assemblies from the “Produces” action, and project items and classes from the “Contains” action are populated in column 400.

So, at this point, a first column 200 has been presented and initially populated with items. From this column, the user made a selection and, responsively, the browser produced a second adjacent column 300 and populated the column with actions that were relevant to the user's selection. From the second column, the user was able to choose one or more actions that pertain to or are otherwise relevant to the items selected in column 200. Responsive to the user's choice of an action or actions in column 300, a fourth adjacent column 400 was produced and populated with the items that constituted the result or outcome of an action selected by the user from column 300.

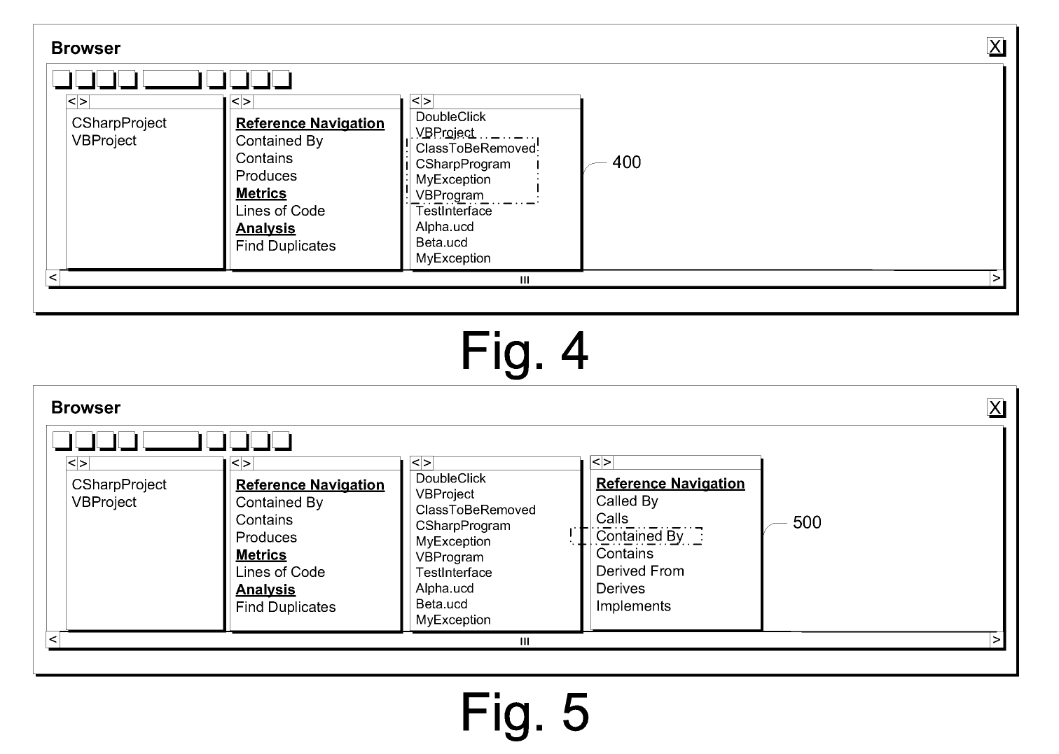

Continuing now, assume the user makes an item selection in column 400 as indicated by the dashed line. In this case, the user has selected four classes. Responsive to the user's selection, a fifth adjacent column 500 is produced and populated with actions that pertain to the items selected by the user in column 400. An example of such a column is shown in FIG. 5 at 500.

Assume now that the user selects the “Contained By” action to ascertain if the classes selected in column 400 are contained by any entities. Responsive to this selection, a sixth adjacent column is produced, such as that shown at 600 in FIG. 6, and populated with items that contain the classes selected in column 400. In the example shown, the selected classes are contained by files (such as Program.cs), assemblies (such as VBProject.dll), namespaces (such as DoubleClick) and projects (such asCSharp Project).

It should be noted that the above example illustrates how structured relationship information can be navigated in a non-hierarchical fashion. Specifically, in this case, classes are related to namespaces, files, projects and assemblies. These relationships are not necessarily hierarchical in nature.

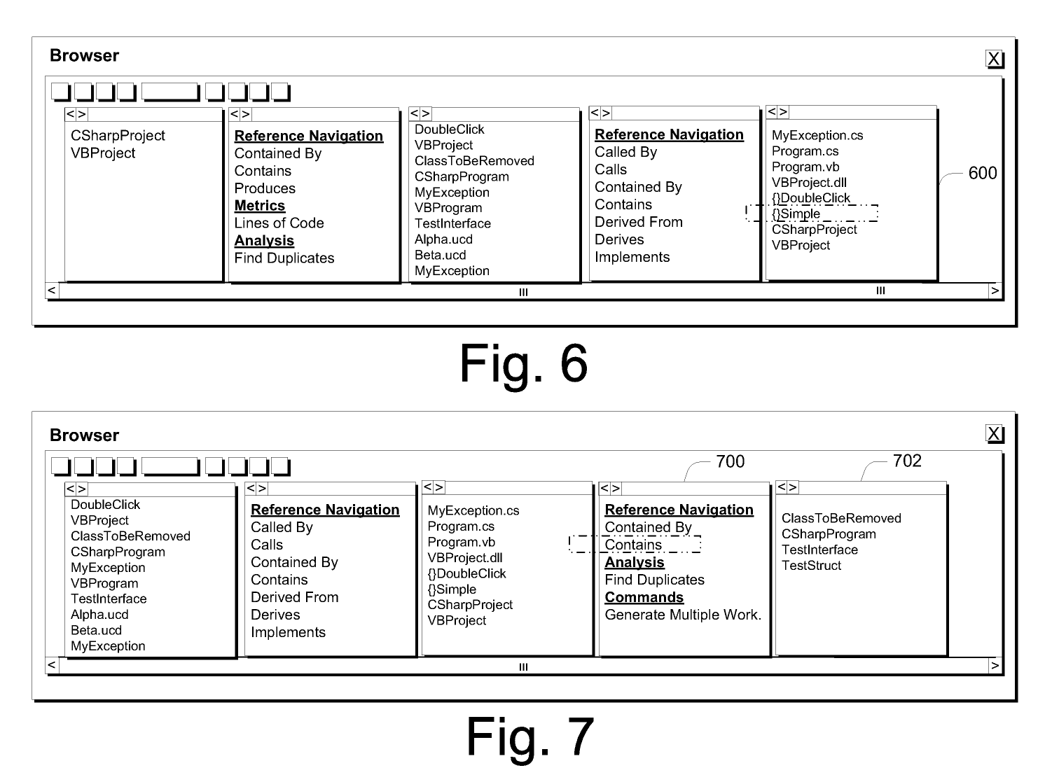

Assume now, in FIG. 6, that the user selects the “Simple” namespace. Responsive to this selection, a next-adjacent column is produced and populated with actions that are relevant to the user's selection. Such a column is shown at 700 in FIG. 7. From here, assume that the user selects the “Contains” action. Accordingly, responsive to this selection, a next-adjacent column 702 is produced and includes two classes, one interface, and one structure.

From here, a user can continue to make selections and have additional columns produced in a cascading fashion. In the illustrated and described embodiment, the cascading item and action browser enables columns of data to be traversed up and down relevant hierarchies, and also enables traversal using a variety of relationships that may not necessarily be hierarchical.

Example Method

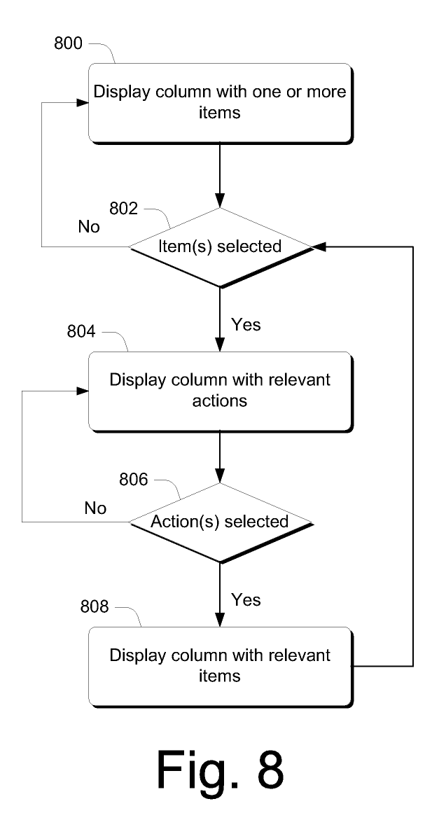

FIG. 8 is a flow diagram that describes steps in a method in accordance with one or more embodiments. The method can be performed in connection with any suitable hardware, software, firmware, or combination thereof. In at least some embodiments, the method can be performed by a suitably-configured cascading item and action browser such as the one described above.

Step 800 displays a column with one or more items. This step can be performed responsive to a user opening or otherwise launching a browser such as the cascading item and action browser described above. For example, when a browser is launched from within an application such as a photo application, the first-displayed column might be populated with photos or files associated with photos that the user has taken. Step 802 ascertains whether the user has selected one or more items. If the user has not selected one or more items, the method returns to step 800 as shown. If, on the other hand, the user has selected one or more items, step 804 displays a column with relevant actions listed. As noted above, the displayed actions are relevant to the user's selection in the previous column. So, in the photo application example mentioned just above, if a user selects a particular photo, the next-displayed column of actions might include such actions as: “share same tag” for returning items that share the same tag as a selected item, “taken same day” for returning items that were taken on the same day, “contain same subject” for returning items that contain the same subject as in a selected item, and the like.

Step 806 ascertains whether the user has selected an action or actions. If the user has not selected an action or actions, the method returns to step 804. If, on the other hand, the user has selected an action or actions, step 808 displays a column with relevant items. The step can be performed in any suitable way and using any suitable items. In the example just above, this step is performed by returning items that satisfy a relationship that is described by an action. Step 800 then returns to step 802. As such, the item-action selection process can continue in a repetitive fashion to build a cascaded column structure as described above.

Example System

FIG. 9 illustrates an example computing device 900 that can implement the various embodiments described above. Computing device 900 can be, for example, computing device 102 of FIG. 1 or any other suitable computing device.

Computing device 900 includes one or more processors or processing units 902, one or more memory and/or storage components 904, one or more input/output (I/O) devices 906, and a bus 908 that allows the various components and devices to communicate with one another. Bus 908 represents one or more of any of several types of bus structures, including a memory bus or memory controller, a peripheral bus, an accelerated graphics port, and a processor or local bus using any of a variety of bus architectures. Bus 908 can include wired and/or wireless buses.

Memory/storage component 904 represents one or more computer storage media. Component 904 can include volatile media (such as random access memory (RAM)) and/or nonvolatile media (such as read only memory (ROM), Flash memory, optical disks, magnetic disks, and so forth). Component 904 can include fixed media (e.g., RAM, ROM, a fixed hard drive, etc.) as well as removable media (e.g., a Flash memory drive, a removable hard drive, an optical disk, and so forth).

One or more input/output devices 906 allow a user to enter commands and information to computing device 900, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide a cascading item and action browser that enables items and associated actions to be displayed. In at least some embodiments, items are presented in a column and can be selected by a user. Responsive to selecting a particular item or items, actions that can be performed on or relative to a selected item or items can be presented in a second adjacent column. From here, users can select one or more actions that can be performed on items presented in the first-mentioned column. Results of the action or actions being performed, at least some of which can include additional items, can then be presented in a next-adjacent column. Navigation through the items and actions displayed in their respective columns can then continue in a cascaded fashion.

In at least some embodiments, individual columns that are displayed by the cascading item and action browser can be displayed in a common container or window. This provides for a degree of visual continuity between items and actions that are presented in the various columns.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
displaying a first column with one or more items;
ascertaining whether a user has selected one or more items; and
responsive to a user selecting one or more items, displaying a second column with actions that are relevant to one or more items selected in the first column.

2. The method of claim 1, wherein said displaying a first column is performed responsive to launching a browser from within an application.

3. The method of claim 1, further comprising:
ascertaining whether the user has selected an action or actions in the second column; and
responsive to the user selecting an action or actions in the second column, displaying a third column with items that are relevant to an action or actions selected by the user in the second column.

4. The method of claim 3, wherein said first, second and third columns are displayed in a common window.

5. The method of claim 1, wherein said first and second columns are displayed in a common window.

6. The method of claim 1 further comprising displaying additional columns responsive to a user selection in a previous column, wherein if said previous column included one or more items, a next-displayed column includes one or more actions, and if said previous column included one or more actions, the next-displayed column includes one or more items.

7. The method of claim 6, wherein displayed columns are displayed in a common window.

8. The method of claim 1, wherein said displaying the second column is performed by displaying one or more action categories and one or more actions underneath at least one category.

9. The method of claim 1, wherein said first and second columns can be used to navigate information having relationships that are not hierarchical in nature.

10. A system comprising:
one or more computer-readable storage media;
computer-readable instructions on the one or more computer-readable storage media which, when executed, provide a cascading items and action browser in which items and actions are represented in different adjacent columns, and wherein actions that appear in one column are populated in the one column responsive to a user selection in an adjacent previous column.

11. The system of claim 10, wherein the cascading items and action browser comprises part of, and can be launched from within an application.

12. The system of claim 10, wherein columns are displayed in a common window.

13. The system of claim 10, wherein columns in which actions appear have action categories underneath which one or more actions can be displayed.

14. The system of claim 10, wherein columns can be used to navigate information having relationships that are not hierarchical in nature.

15. A system comprising:
one or more computer-readable storage media;
computer-readable instructions on the one or more computer-readable storage media which, when executed, implement a method comprising:
launching a browser from within an application;
displaying, with the browser, a first column with one or more items;
ascertaining, with the browser, whether a user has selected one or more items;
responsive to a user selecting one or more items, displaying, with the browser, a second column with actions that are relevant to one or more items selected in the first column.

16. The system of claim 15, wherein the method further comprises:
ascertaining, with the browser, whether the user has selected an action or actions in the second column; and
responsive to the user selecting an action or actions in the second column, displaying, with the browser, a third column with items that are relevant to an action or actions selected by the user in the second column.

17. The system of claim 16, wherein said first, second and third columns are displayed in a common window.

18. The system of claim 15, wherein said first and second columns are displayed in a common window.

19. The system of claim 15, wherein the method further comprises:
displaying additional columns responsive to a user selection in a previous column, wherein if said previous column included one or more items, a next-displayed column includes one or more actions, and if said previous column included one or more actions, the next-displayed column includes one or more items.

20. The system of claim 19, wherein displayed columns are displayed in a common window.
